(19) United States
(12) Patent Application Publication
(10) Pub. No.: US 2005/0216351 A1
(43) Pub. Date: Sep. 29, 2005

(54) Methods and systems for recovery of sales and use taxes on cross-state direct sales, mail order, and electronic commerce

(76) Inventors: Kenneth Holbert, Easley, SC (US); Leei Mao, Greenville, SC (US); Mark Sejman, Greenville, SC (US)

Correspondence Address: Kenneth Holbert, Jr., 104 Sun Blvd., Easley, SC, 29642, US

(21) Appl. No.: 11/058,466

(22) Filed: Feb. 15, 2005

Related U.S. Application Data
(60) Provisional application No. 60/544,307, filed on Feb. 17, 2004.

(51) Int. Cl. G06F 17/60

(52) U.S. Cl. 705/19

(57) ABSTRACT

Tax revenue losses to electronic commerce generally arise because electronic commerce enables a significant increase in remote sales, thereby causing a shift from collecting sales tax at the point of sale to collecting use tax in the state. Numerical studies show that the sales/use tax base is quickly eroding in the United States and countries in the world due to online, Internet electronic commerce purchases. Establishing an effective, accurate and efficient system for recovering sales and use tax by forming an electronic commerce Tax Recovery Center is designed. This Tax Recovery Center will be the hub of all electronic commerce information for all fifty states. Business transaction data on the Internet will be collected, secured and delivered to each state revenue agency in the format that each individual state requests. Geographic Information Systems (GIS) technology will be used to provide jurisdictions and municipalities' data to assist and enforce collection of use tax from instate purchasers. Out of state sellers, on which local government does not have jurisdictional grip cannot require collection of use tax from their customers. Vendors transactions records on the Internet will be acquired, collected, and processed, so that each state tax revenue agency will be able to enforce the existing use tax law. A 1099x tax form or equivalent tax notice will be furnished to purchasers to allow payment of use tax for the previous calendar year. In-state purchasers report use tax on the appropriate line of the state income tax return form.

### CROSS-REFERENCE TO RELATED APPLICATIONS

The present application claims priority on and contains subject matter related to that disclosed in commonly owned, co-pending provisional application 60/544,307 filed on Feb. 17, 2004.

### FEDERALLY SPONSORED RESEARCH

Not Applicable

### SEQUENCE LISTING OR PROGRAM

Not Applicable

### BACKGROUND OF THE INVENTION

1. FIELD OF INVENTION The present invention relates to method and system for recovering of sales and use tax currently uncollected by state and local taxing authorities on cross-state direct sale, mail order, and electronic commerce via the internet. Vendors' transactions records on cross-state direct sale, mail order, and Internet sales will be collected, secured and delivered to each tax revenue agency. Geographic Information Systems (GIS) will be utilized to assist with jurisdictions and municipalities to ensure the accuracy of the correct local tax rate applied to each purchase and to enforce the existing use tax law for local tax districts to get their fair share of the revenue.

2. Discussion of Background

In the United States, nearly every state and many municipalities collect sales and use tax ranging from zero to eleven percent (0-11%) on goods and services purchased within the state. Numerical studies show the sales tax base for state and local government has been shrinking due to the majority of sales that take place on cross-state direct sale, mail order, and electronic commerce which are either not taxed or not accurately taxed by either the state in which the selling company is located or the state in which the purchase is conducted. This is due to the prevailing taxation system, which uses zip codes to determine local tax rate. The problem with the prevailing system is that zip codes are designed for mail delivery routes and do not necessary reflect the county line or metropolitan borderline.

Revenue losses of electronic commerce generally arise because electronic commerce enables a significant increase in remote sales, thereby causing a shift from collecting sales tax at the point of sale to collecting use tax in the state. Numerical studies show that the sales and use tax base is quickly eroding in the United States due to online, Internet electronic commerce purchases. The instant invention seeks to create an effective, accurate and an efficient system for recovering sales and use tax by forming an electronic commerce Tax Recovery Center, which will be the hub of Internet electronic commerce sales and purchase information for all tax revenue agencies. According to eBay, registered users have increased from 42.4 millions in 2001 to 135.5 millions in 2004 while the dollar volume of goods sold have increase from 9.3 billions in 2001 to 34.2 billions in 2004. Some business offer digital real estate for small merchants may actually do collect sales tax at the point of sale but most of them don't.

Numerical studies show that the sales and use tax base is quickly eroding in the United States due to online electronic commerce. To achieve these objects, the present inventors have invented an effective, accurate and an efficient system for recovering sales and use tax by forming a Tax Recovery Center. This Tax Recovery Center will be the hub of all cross-state direct sale, mail order, and electronic commerce. Vendors' transactions including sales and purchase information will be processed according to the tax liability of each tax district for tax revenue agencies (such as State Department of Revenue).

U.S. Pat. No. 6,016,479 issued to Taricani, Jr. discloses a Computer-based system, computer program product and method for recovering tax revenue which is also a system for recovering tax revenue currently not being recovered by storing data in a database indicating interstate sales transactions on which a seller does not collect a designated tax, such as a sales tax. However, the Taricani, Jr. patent does not recover use tax and does not use geocoding method to identify tax district from the address provided by vendors. The major advantage in using goocoding method is the bigger the database it has been used, the more accurate it will be; without using geocoding method, there exist a certain error rate in address matching processes, so it would not apply accurate tax rate to the taxpayer.

### OBJECTS AND ADVANTAGES

The advantages of this invention are:
A. It does not require any new legislation; and
B. It facilitates direct assessment of taxes

The current patchwork of 7,458 taxing jurisdictions across the country is too complex and burdensome for online retailers to charge and collect sales taxes. The courts have ruled that sellers practice electronic commerce on internet does not have to collect taxes because of the jurisdictional complexity, but nothing prevents the collection of the taxes by the states if the states can identify the transactions. However, the process of applying the patchwork of tax laws on cross-state direct sale, mail order and Internet Sales and purchases for all 7,458 taxing jurisdictions across the country will result in waste and duplication. The present invention does not require multi-state cooperation. It not only provides support for the various states' department of revenues to maintain their own integrity in enforcement of state tax statutes without intervention of a third party, but it also formation of a use tax form (1099x) and provides the accurate information that is currently required to go on the state income tax form. Moreover, vendors transactions data processed at the Tax Recovery Center have qualitative and quantitative characteristics that are different from data archived at the state department of revenue. This fact makes the data valuable in two ways; first, these data, if grouped by state, can be used to recover taxes lost on electronic commerce or prevent said loss. Secondary, these data can be used to strengthen the tax base and reduce the cost of collecting sales and use tax. No new taxes are expected from the tax recovery processes.

### SUMMARY

Internet sales are estimated to have topped $123 billion in 2004. Of the thirty-nine states with individual state income taxes as well as sales taxes, roughly eighteen states and New York have a line item to call on taxpayers to pay taxes on out-of-state purchases on their income tax form and three have a separate form in their income tax packages. But state tax revenue from Internet purchase with out-of-state firms remains a fraction of the estimated uncollected sales tax because of the lack of a way to enforce it.

It is therefore an object of the instant invention to present a Tax Recovery Center to be the hub of all cross-state direct sale, mail order, and online sales and purchase information for all fifty states. All transactions will be brought to the assessment level, collected, secured and delivered tax notices to tax revenue agencies in the format that each individual agency requests. Sellers are not required to collect sales taxes for all taxing jurisdictions on cross-state direct sale, mail order, and online sales. Geographic Information Systems (GIS) are used to help each of the 7,458 sales-taxing jurisdictions in the United State to calculate and issue tax notices to tax payers in their jurisdiction to pay sales taxes on Internet purchases according to the local laws.

### BRIEF DESCRIPTION OF THE DRAWINGS

A more complete appreciation of the present invention, and many of the attendant advantages thereof, will be readily obtained as the same becomes better understood by reference to the following detailed description when considered in connection with the accompanying drawings, wherein:

FIG. 1 is a block diagram showing an overall summary of system database and its symbols.

FIG. 2 is a block diagram showing an overall system configuration of the present invention;

FIG. 3 is a block diagram showing more detailed processing procedures to convert vendors' transactions records into system transaction table for further processing. In this processing, transaction data from vendors is loaded into the database producing a transaction table for further processing.

FIG. 4 is a block diagram of more detailed matching processes to apply accurate tax rate to buyer address base on GEOcodes. In this processing, transaction table generator in FIG. 3 is matched against taxpayer table and taxpayer address table in the database which provided by the tax revenue agency to determine tax rates based on location of ship to address or buyer address using GEOcodes. Taxpayer transaction table and tax notices are then generated for tax recovery.

FIG. 5 is block diagrams showing review process in error correction. Unmatched addresses are manually inspected. Some causes of unmatched addresses are: incorrect address table entries, Post Office box addresses, and incorrect or missing centerline address ranges.

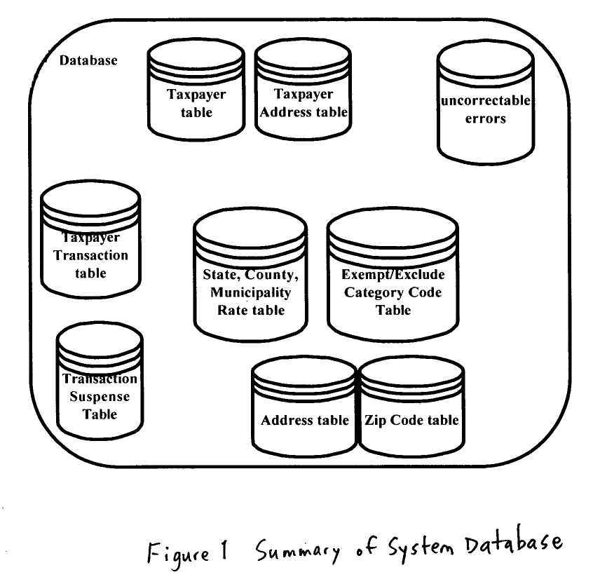

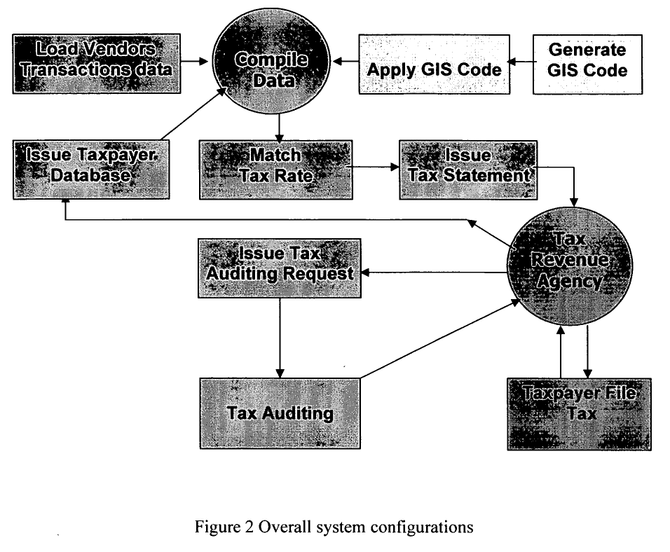

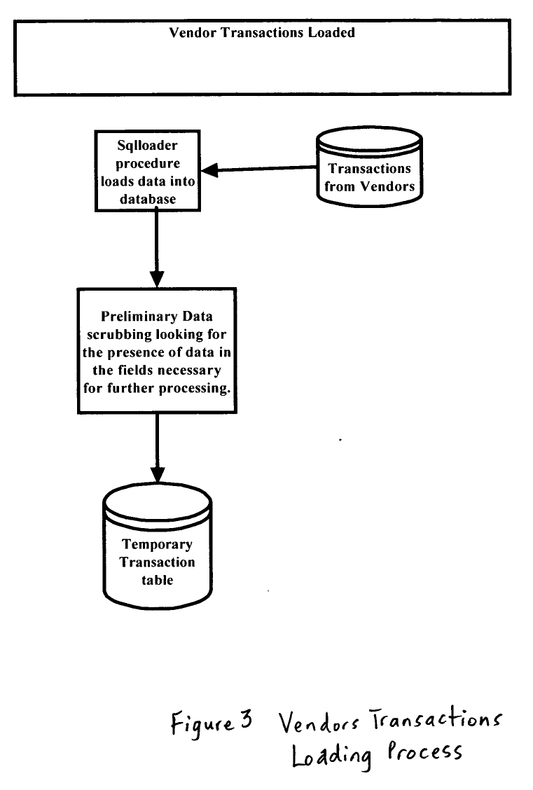

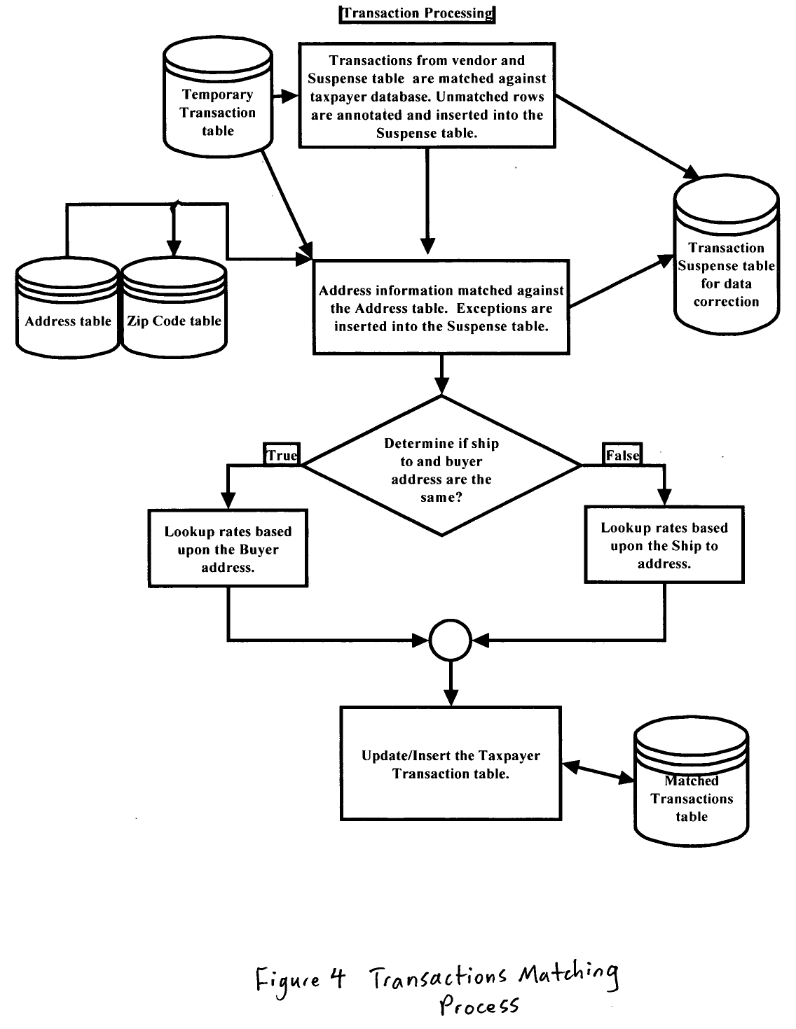

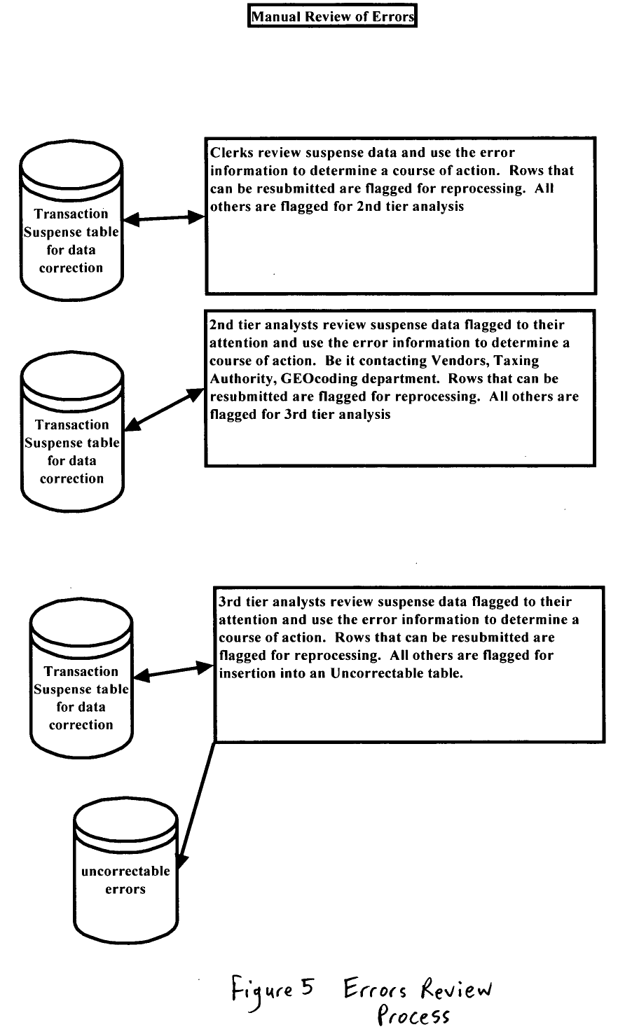

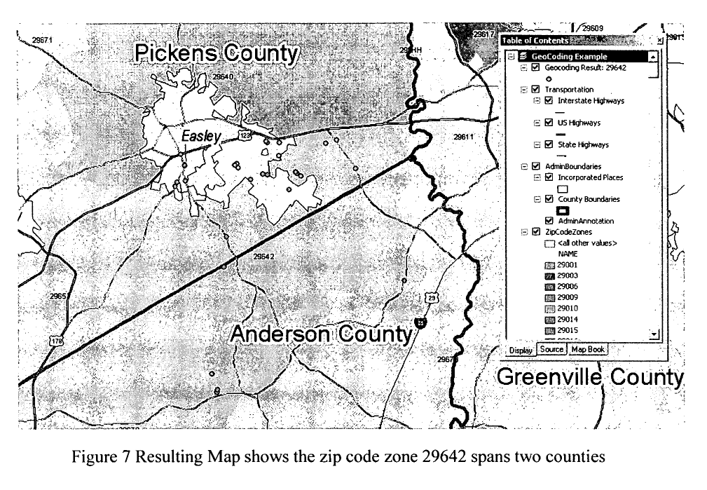

### DRAWINGS—SYSTEM PROCESSING FLOW CHARTS

### DETAILED DESCRIPTION

Technology implanted shall be run on a variety of computing platforms and operating
systems and will not be restricted to any sole vendor, appliance, or operating system.

Information processing will be in several steps. The first process involves the loading of taxpayer information. This information includes taxpayers from the previous year as well as information amassed from payroll cycles in the current year. The information will be loaded directly to the database, with in-program housekeeping and exception reporting.

Depending upon the frequency of data submission and number of transactions, the on-line purchase information may be bundled. Initial processing will be at the operating system level to decode/clean the data. The resultant dataset would be then submitted for processing against the taxpayer data with summary information stored. Housekeeping and exception reporting will also be performed at this time.

Several considerations will be taken into account. Since we are a mobile society, correct identification of residency status at the time of purchase is a must. Taxes collected by entities with a presence in state will be identified.

Information returned to the tax revenue agency (such as State DOR) will include Taxpayer information that was originally sent as well as the use tax amount. This will need to be divided into totals for state and local-options (if applicable).

Delivery of data to each individual state's department of revenue in the United States or any other country's tax revenue agency shall be accomplished via private wired or wireless internet interconnection, virtual private network or other secure means such that the data produced shall be only available to the department of revenue or the equivalent tax revenue agencies. This transmission shall contain all information required to allow for the official disbursement of the appropriate forms to those individual taxpayers of each state whose tax liability shall be discovered from data supplied to the electronic commerce/internet Tax Recovery Center.

Original data and transaction records provided to the Tax Recovery Center shall not be dispersed or shared with any enterprise for any purpose. Such data shall be regarded by the Tax Recovery Center as the sole property of the correspondent state government and shall be returned to each individual state at the termination of contract and upon full payment of all outstanding debt, or upon the day in which the company shall be dissolved as an incorporated entity.

The Tax Recovery Center shall make access to the original data and transaction records available only to authorized representatives of each state who are named in writing at the time of contract. Access to the data shall occur only on the site where data is physically located. No data shall be released from the site until such time that the data shall be dissolved or the term of contract has been reached.

User access to the data shall be provided in reasonable facsimile to actual statement data via a virtual private network connection, or a secure wired or wireless Internet connection that will utilize a proprietary programming to interface to the working data used in production of the actual billing to individuals and delivery of such data to the department of revenue of each individual state.

Data deployment to each state shall consist of the invoices for purchases made from any site of electronic commerce which that state's department of revenue has acquired data or caused data to be acquired. This data shall contain the known address and social security number (or official identification number) of that individual and the amount of each purchase for which data has been supplied by the state. Access to the said data by the department of revenue shall be made available as stated in Paragraph #4 and by the use of proprietary programs written by the Tax Recovery Center.

Vendors transactions records on electronic commerce/internet will be collected, secured and delivered to each state revenue agency in the format that each individual state requests. This will allow each state to maintain their own integrity by allowing enforcement of their tax statutes without intervention of a third party.

Geographic Information Systems (GIS) will be utilized to assist jurisdictions and municipalities' data to assist and enforce collection of appropriate percentage sales and use tax from instate purchasers. Out of state sellers are not required to collect sales and use tax for all tax jurisdictions on internet sales. GIS are utilized to assist each of the taxing jurisdictions to calculate and issue sales and use tax notices to the tax payers in their jurisdiction.

Business transaction data on the Internet will be acquired, collected, and processed, so that each state tax revenue agency will be able to enforce the existing use tax law. A tax form will be designed and furnished to purchasers to allow payment of use tax for the previous calendar year. In-state purchasers report use tax on the appropriate line of the state income tax return form.

Examples of the use of GIS are as follows:
Overlaying taxing district, census geography, and legislative coverage with the geocoded residential data (point data representing street address location); performing point-in-polygon geoprocessing and tag tax district, census geography, and legislative codes to individual address records. After geoprocessing, the 5 million records will have the income tax filer's name (for confidentiality purposes), address, city, ZIP+4, and the county, township, incorporated place, census tract, block group, block, school district, junior college district, park district, legislative district, etc., where that person lives.
Geocoding over 250,000 business tax filers and overlay taxing district, census geography, and legislative coverage with the geocoded business data (sales tax and business registration); perform point-in-polygon geoprocessing and tag tax district, census geography, legislative codes, etc., to individual address records. The data fields are the same as those listed above for the geocoded residential data.

In the United States, data has shown zip code centroids are used to determine the county, but the area covered by a zip code may include adjacent counties (8). These types of area-based relationships are where GIS can be extremely useful.

Description of how Geocoding Works

Geocoding is the process of finding the geographic location for an address. Geocoding allows us to locate addresses on maps, validate addresses, assign geopolitical areas to addresses, and in this invention, we can use Geocoding to determine the taxing districts where the addresses are located and ensure that local taxing districts get the correct amount of revenue.

There are three requirements for Geocoding:
A table of addresses to be located
A centerline file serve as a vector based GIS database containing road and street data with addressing information
A Geocoding service platform which GIS software capable of matching addresses to centerlines

An example with one of the addresses from the test taxpayer address table. The addresses were chosen at random from a Google search for addresses with 29642 zipcode. The address table is a small random sample of addresses in the 29642 zipcode zone.

[image]

The TIGER/Line files are extracts of selected geographic and cartographic information from the Census Bureau's TIGER® (Topologically Integrated Geographic Encoding and Referencing) database. ESRI (Environmental Systems Research Institute), ArcGIS software was used for the Geocoding service. ESRI (Environmental Systems Research Institute) is one of the leading makers of Geographic Information Systems software products. The line segment where this address is located is shown in the database view. Only the fields used to determine the address are shown.

Each road segment in a centerline file contains fields that represent the house address and zone numbers from/to on the left and right sides of the segment. When creating a Geocoding service, the reference database (centerline file) is indexed to speed the Geocoding process. This information can reside in an external database. The Geocoding service can be configured to dynamically link to the address table allowing automatic updates as the address information changes. Good centerline data is the most important aspect of Geocoding. The actual geocoding process is run from within ArcMap, the main editing application of the ArcGIS suite. The address table input fields are automatically recognized based on the names setup in service. After picking an output location, the process is started.

The review/rematch will screen shows the results of the process. Matches are plotted on the resulting map. Unmatched addresses are manually inspected. FIG. 7 is a resulting map shows the zip code zone 29642 spans two counties (Anderson and Pickens) and one incorporated city (Easley). Clearly there are at least three tax districts represented by this one zip code. Matches addresses are plotted on the resulting map. Unmatched addresses are manually inspected. Some causes of unmatched addresses are: incorrect address table entries, Post Office box addresses, incorrect or missing centerline address ranges. The same issues exist with the zipcode zone 29673 spanning Anderson and Greenville counties. These are just two examples of where locating the address on a map helps clarify and supplement the address information.

Description of Computer Match Transaction

I. Initialization

Program Initialization
This procedure performs various housekeeping tasks and calls the tax Rates and Exempt Category load routines.
The purpose for these loads is to utilize memory tables and minimize disk I/O.
   Parameters In: State Code
      In/Out: Tax Rates, Exempt Categories.

Load Rates
This procedure loads the rate tables for the State code passed in from the program initialization routine.
   Parameters In: State Code
      In/Out: Tax Rates

Load Exemption Categories
This procedure loads the exemption categories for the State code passed in f rom the program initialization routine.
   Parameters In: State Code
      In/Out: Exempt Categories
         II. Processing

Get Sales Info
Cursor Defined for the sales information. This table is loaded from a flat file sent from an online vendor.
The purpose of preloading this table is utilize the SQL-loader speed for data loading and to avail ourselves to
Indexing features. These are not available with external tables or simple flat OS files.

Data Validation
This routine performs simple data validation for the sales date and amount. This is to be sure that these values are correct and available for further processing.
   Parameters In: Sales Transaction Record
      In/Out: “Y/N” indicator that further processing is allowed.

Get Taxpayer Database
This procedure retrieves taxpayer information based upon the full name, as other identifiers are presented (social security number) this routine will be cloned.
   Parameters In: Full Name
      In/Out: Taxpayer record, “Y/N” indicator

Check Exempt Status
This procedure uses the transaction category to read the Tax exempt and exclusion table. The Percentages returned are utilized later in the program.
   Parameters In: Transaction record, Exemption Categories
      In/Out: Exempt percent, Exclude percent

Get Address
This procedure returns the geo-coded address, based upon the transaction address information passed. If the ship-to address is not the same as the billing/buyer address, we will pass that information.
   Parameters In: Transaction Street, Transaction Zip
      In/Out: Address Record
      Out: “Y/N” indicator that the address was found.

Match Address
This function validates the address based on the transaction date.
   Parameters In: Taxpayer Id, Address Id, Transaction Date
      Out: “Y/N” Indicator that buyer/taxpayer addresses match

Get Tax Rates
This procedure takes the State, county and municipality, the Tax rate table and performs a match to determine the appropriate rates. Returned information is the local option code and rate, capital project code and rate, Special district code and rate.
   Parameters In: Tax rates, State, County, Municipality
      In/Out: Rate Found Record

Process Match
This procedure processes the data and inserts/updates information based on the tax year of the transaction. Each procedure reports exceptions and the transactions are loaded to a suspense table for review.
Parameters In: Taxpayer record, Address record, Transaction Record, Tax Rate information, Exempt percentage, Exclude percentage.

### REFERENCES

1. U.S. Pat. No. 6,016,479
2. D. Bruce and W. Fox, “Tennessee Summary, State and Local Sales Tax Loss Revenue Losses from Electronic commerce/internet—Updated Estimates”, University of Tennessee at Knoxville, October 2001.
3. D. Bruce and W. Fox, “State and Local Sales Tax Loss Revenue Losses from Electronic commerce/internet—Updated Estimates”, University of Tennessee at Knoxville, September 2001.
4. Bruce, Donald, and W. Fox, “Electronic commerce/internet in the Context of Declining of State Sales Tax Base”, National Tax Journal, Vol. 53, No. 4 (December 2000, part 3), page 1373-1388.
5. United State Court of Appeals for the Ninth Circuit No. 02-15035, Filed Sep. 2, 2003.
6. “Creating Integrated Tax Systems for State and Local Tax & Revenue Agencies”, Larstan Business Reports, 2003.
7. Kenneth Daniel, “Internet Taxation and the Streamlined Sales Tax Simplification Project”, Dec. 28, 2001.
8. USA Today, Wednesday, Feb. 2, 2005, Section 3B.

1. A method for recovery of sales and use tax related to a purchase on cross-state direct sale, mail order, and electronic commerce/internet using a Tax Recovery Center, comprising the steps of:
storing vendors transactions activities on a Tax Recovery Center or its kind;
storing sale and purchase transactions data related to said transaction on cross-state direct sale, mail order, and electronic commerce; and
calculating sales and use tax liability on said transactions data using geocoding matching techniques.

2. The method according to claim 1 further comprising the step of providing said taxes information to fifty states in the United States and to any other country in which said purposes which it may apply.

3. The data of said method according to claim 1 wherein said related sale or purchase transactions on cross-state direct sale, mail order, and electronic commerce comprises:
the date, name, identification number, address, price of goods or service of said transaction;
the billing and shipping location of the individual that made the said purchase through an cross-state direct sale, mail order, and electronic commerce transaction;
the state levying said sales or use tax on electronic commerce;
the total amount of said sales and use tax owed in association with said transaction; and
the total cumulative liabilities of each individual for a calendar year beginning January 1, and ending December 31 of a given year.

4. The method according to claim 1 wherein said calculating step comprises the steps of:
determining whether said sale or purchase on cross-state direct sale, mail order, and electronic commerce is subject to said tax;
calculating the amount of sales or use tax associated with said transaction on cross-state direct sale, mail order, and electronic commerce; and
printing said total tax amount to an amount of tax on Tax Forms; and
made the detail of transactions on cross-state direct sale, mail order, and electronic commerce sale and purchase available on the website of Tax Recovery Center for taxpayer to download.

5. The method according to claim 1 wherein said tax recovery application can be used to recover taxes lose to more than one state.

6. The method according to claim 1 wherein said culmination off this patent would be to warehouse all of the electronic commerce transactions.

7. The method according to claim 1 can be used for one cross-state direct sale, mail order, and electronic commerce vendor or an infinite number of vendors.

8. The method according to claim 1 can be run on a variety of computing platforms, operating systems, database tables and will not be restricted to any sole vendor, appliance, or operating system.

9. The method of delivery data to each individual state Department of Revenue in the United States or any other country's tax collecting agency according to claim 1 shall be accomplished via private internet interconnection, VPN or other secure means such that the data produced shall be only available to the Department of Revenue or the equivalent tax collecting agency.
